(19) United States
(12) Patent Application Publication
(10) Pub. No.: US 2015/0173108 A1
(43) Pub. Date: Jun. 18, 2015

(54) SYSTEMS AND METHODS FOR SWITCHING A SET OF WIRELESS INTERACTIVE DEVICES

(71) Applicant: QUALCOMM Incorporated, San Diego, CA (US)

(72) Inventor: Prudvidhar Thangella, San Diego, CA (US)

(73) Assignee: QUALCOMM Incorporated, San Diego, CA (US)

(21) Appl. No.: 14/106,247

(22) Filed: Dec. 13, 2013

(51) Int. Cl. H04W 76/02

(52) U.S. Cl. CPC H04W 76/02

(57) ABSTRACT

Systems and methods switch interactive devices wirelessly connected with a first computer to wireles sly connect to a second computer when one of the interactive devices is switched to interact with the second computer. The interactive devices may be a keyboard, a mouse, a printer or a display device. An interactive devices that has an active connection to a first computer, to wireles sly provide the first computer interactive user information input into the interactive device, or to wirelessly receive output data from the first computer, may generate and transmit a data packet that includes information of the interactive device, the computing device the interactive devices is actively connected to, and any standby devices the interactive devices is communicating with. When the interactive devices is switched to the second computer, the interactive devices may generate another data packet indicting the new active computing device and standby devices, for example, previous active devices.

### FIELD

This application relates generally to wireless communications, and more specifically to systems and methods for connecting wireless devices.

### BACKGROUND

Computing devices may communicate wireles sly to an interactive device to receive input from a user or to provide information to a user. For example, a desktop computer may communicate with a wireless keyboard to receive user input. In another example, a desktop computer may communicate with a wireless mouse or other pointing device to receive input from a user. One example of a user output device includes a monitor, or other display device, wireles sly communicating with a desktop computer to receive image data for display to a user. A computer and a device used to interact with the computer may communicate with any appropriate configured protocol, for example Bluetooth.

Many people have more than one computer at home, for example, a laptop, a tablet computer, a smartphone, and/or a desktop computer. Interactions with such computers may include using a separate keyboard, mouse and/or monitor (or display device). In addition, today's video systems are becoming more complex and often include functionality that may have been previously only found on a standalone computing system. Such systems may be configured to include functionality to communicate with another device besides a remote control, for example, a smartphone, a wireless keyboard, or a portable computer. As the number of wireless computers and interactive devices within a computing environment increase, it would be advantageous to have better ways to manage the connections of the interactive devices to the computing devices.

### SUMMARY OF THE INVENTION

A summary of sample aspects of the disclosure follows. For convenience, one or more aspects of the disclosure may be referred to herein simply as “some aspects.”

Methods and apparatuses or devices being disclosed herein each have several aspects, no single one of which is solely responsible for its desirable attributes. Without limiting the scope of this disclosure, for example, as expressed by the claims which follow, its more prominent features will now be discussed briefly. After considering this discussion, and particularly after reading the section entitled “Detailed Description” one will understand how the features being described provide advantages for switching a plurality of user interactive devices from interactively communicating with one computing device to interactively communicating with another computing device.

In one innovation, a system for switching wireless connections of a plurality of interactive devices from a first computing device to at least a second computing device includes a first interactive device. The first interactive device includes a memory unit configured to store information identifying active and standby computing devices, a wireless transmitter and receiver operationally coupled to the memory unit, an interface configured to receive input from a user, the interface configured to receive an input from a user signaling to switch the interactive device from providing interactive input from a first computing device to a second computing device, and a processor coupled to the memory unit, the processor configured to retrieve the information identifying active and standby computing devices from the memory unit, generate a data packet that includes specific information of the first interactive device, address information of an active computing device and address of one or more standby computing devices, and information indicating which of the standby devices was more recently connected to the first interactive device, and to wireles sly transmit the data packet using the transmitter.

Another innovation includes a method for switching wireless connections of a plurality of interactive devices from a first computing device to at least a second computing device, the method including transmitting wirelessly a first data packet from a first interactive device that is in an active connection mode with a first computer identified in the first data packet, the data packet including information identifying the interactive devices transmitting the data packet and identifying an active computing device that is in an active connection mode with the interactive device transmitting the data packet, the data packet further including information identifying any standby computing devices that are in an inactive connection mode with the interactive device transmitting the data packet, switching the first interactive device to be in an active connection mode with a second computing device and in an inactive connection mode with the first computing device, and transmitting wirelessly from the first interactive device a second data packet, the second data packet including information indicating that the first interactive device is in an active connection mode with the second computing device identified in the second data packet as an active device and in an inactive connection mode with the first computing device identified in the second data packet as standby device.

Another innovation includes a computer readable medium comprising instructions that, when executed, cause an apparatus to perform a method for switching wireless communications of a plurality of interactive devices from a first computer to at least a second computer, the method including transmitting wirelessly a first data packet from a first interactive device that is in an active connection mode with a first computer identified in the first data packet, switching the first interactive device to be in an active connection mode with a second computing device and in an inactive connection mode with the first computing device, and transmitting wireles sly from the first interactive device a second data packet. The first data packet can include information identifying the interactive device transmitting the data packet and identifying an active computing device that is in an active connection mode with the interactive device transmitting the data packet, the data packet further including information identifying any standby computing devices that are in an inactive connection mode with the interactive device transmitting the first data packet. The second data packet can include information indicating that the first interactive device is in an active connection mode with the second computing device identified in the second data packet as an active device and in an inactive connection mode with the first computing device identified in the second data packet as a standby device.

### BRIEF DESCRIPTION OF THE DRAWINGS

FIG. 1 is a schematic illustrating an example of a system of a plurality of interactive devices in communication with one of a plurality of computing devices in an active connection mode and the other of the plurality of computing devices in an inactive communication mode.

FIG. 2 is a schematic illustrating an example of three interactive devices wireles sly connected to a first computing device (a laptop) in an active connection mode and wireles sly connected to two other computing devices (a desktop computer and a tablet computer) in an inactive communication mode.

FIG. 3 is a schematic illustrating an example of the three interactive devices illustrated in FIG. 2 now wireles sly connected to a second computing device (the desktop) in an active connection mode and wireles sly connected to the two other computing devices (the laptop and the tablet) in an inactive communication mode.

FIG. 4 is a schematic illustrating an example of the three interactive devices illustrated in FIGS. 2 and 3, now wireles sly connected to a third computing device (the tablet) in an active connection mode and wireles sly connected to the two other computing devices (the laptop and the desktop) in an inactive communication mode.

FIG. 5 illustrates communications between the three interactive devices illustrated in FIGS. 2-4.

FIG. 6 illustrates an example of an implementation of a data packet that may be generated and transmitted by an interactive device, for example, interactive devices illustrated in FIGS. 1-5.

FIG. 7 illustrates an example of an implementation of a data packet that may be generated and transmitted by an interactive device, for example, interactive devices illustrated in FIGS. 1-5.

FIG. 8 is a schematic illustrating an example of one implementation of an interactive device.

FIG. 9 is a flowchart illustrating an example of a method for switching a set of interactive devices from a first computer to a second computer.

FIG. 10 is a block diagram of an interactive device that may be used in implementations of the invention.

### DETAILED DESCRIPTION OF CERTAIN EMBODIMENTS

The following detailed description is directed to certain specific embodiments of the invention. However, the invention can be embodied in a multitude of different ways. The aspects herein may be embodied in a wide variety of forms and any specific structure, function, or both being disclosed herein is merely representative. An aspect disclosed herein may be implemented independently of any other aspects and two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

This disclosure includes certain methods, systems and apparatuses that generally relate to switching two or more wireless interactive devices that are wirelessly connected with a first computer, for input or output functionality, to wireles sly connect with a second computer when one of the interactive devices is switched to interact with the second computer. In some implementations, the interactive devices may be devices that interact or communicate with a human user. In some implementations, the interactive devices may interact or communicate with one or more non-human systems, for example, a computer system, communication systems and devices, machinery incorporating wireless communications to receive input and provide output, wireless devices and components, robots and/or automated processes.

Features described herein enable an interactive device to switch an active connection from a first computer to another computer, and other interactive devices also switch from the first computer to the other computer such that a set of interactive device's switch between the first computer and the at least one other computer when one interactive device initiates the switching from the first computer to the other computer. In this way, the set of interactive devices are actively connected to the same computer to provide input and/or receive output from the computer the set of interactive devices are connected to by only switching one interactive device. That is, a set of interactive devices may be switched from one computer to another computer by switching one interactive device to the other computer. Due to communication and processing times, the set of interactive devices may be switched nearly simultaneously. Features of certain implementations may include the ability to advertise the actively connected details once in active connection mode, the ability to detect the advertised packets from other interactive devices and which are all connected to the same computer now and then switch a set of interactive devices to another computer which obviates switching each interactive device individually, an active connection mode where data is communicated between interactive devices, and a standby mode that may include keeping the connection in a power save mode without any no data communication. In any of the implementations herein, unless otherwise stated, examples of input interactive devices may include, but are not limited to, one or more of a mouse, a pointing device, a touchpad, a stylus/pad combination, a joystick, a trackball, a system that receives input signals based on one or more gestures (for example, but not limited to, a movement of a user's finger, hand, head, arm or eye), voice commands, or a keyboard. An output interactive device may be, for example, a display, computer monitor or a television monitor.

More specifically, certain innovations described and illustrated further herein relate to switching a set of two or more devices that are wireles sly interacting with a first computer to interact with a second computer by providing an input to only one or the set of devices. In one example implementation, a home computing environment may include numerous computing devices including a desktop computer, a tablet computer, and a television system having a computer implemented therein. These computing devices have processors, memory units, transmitters and receivers, and incorporate functionality to allow wireless communication with the computing devices to receive user input (for example, user commands and selection indications) sent to the computing devices and/or to receive output (for example, images to display on a monitor or an another display device, or communication information) from the computing devices. A user may have a number of interactive devices, for example, a keyboard, a mouse, a printer and a display that are wireles sly communicating with, and interactively connected, to the desktop computer, where input to the desktop computer is provided by the keyboard and the mouse, and output from the desktop computer is provided by at least the printer and the display which receive output from the desktop computer to convey information to the user.

If a user desires to communicate with the television system instead of the desktop computer, the user may provide input to the keyboard to indicate that the wireless keyboard should switch and now interactively communicate with the television system. Upon receiving the user input to switch to interactively communicate with the television system, the wireless keyboard may generate a data packet that includes information indicating the keyboard is now interactively communicating with the television system so that inputs from the keyboard are sent to, received by, and acted on by the television system and not the desktop computer. The data message may indicate that the television system is now the active computing device, that the desktop computer is the most recently connected to standby computing device, and that the tablet computer is another standby computing device. The keyboard can wirelessly transmit the data packet and it is received by other interactive devices communicating with the desktop computer system, for example, the mouse, the display and the printer. Based on the information in the packet, the mouse, display and printer then also switch to actively communicate with the television system without the need for a further user action to switch these interactive devices.

When a user wants to switch back to the desktop computer or switch to the tablet computer, the user can again provide input to the keyboard to switch the keyboard to connect to a desired computing device, for example, the tablet. In response, the keyboard can generate and transmit another data packet (a second data packet) to the other interactive devices indicating that the keyboard is now actively interacting with the tablet computer and that the television system is the most recently connected to standby device and the desktop system is another standby computing device that may be actively connected to, if desired. Based on the information in the second data packet, the display, mouse and printer also switch over to communicate with the tablet computer as the active computing device. The display, mouse and printer may then also generate and transmit a data packet indicating the tablet computer is the active computing device, the television system is the most recently connected to standby device.

One advantage of such methods, systems and apparatuses is efficiency, for example, the decrease in time to switch a plurality of interactive devices from actively communicating with a first computer, for interactive input and receiving output, to actively communicating with a second computer for interactive input and receiving output. Another advantage is the ease of operation in that a user has to switch only one interactive device from communicating with an active computing device to a standby computing device (making the standby computing device the new active computing device), and other interactive devices follow, that is, they may also switch to the new active computing device.

The examples of implementations of systems and methods described herein are applicable to many communication technologies including Bluetooth wireless technologies. However, the systems and methods may also be implemented using other wireless technologies (for example, Wi-Fi) or networks that include functionality for communications between multiple computers or computer related communication devices.

Further, the systems and methods described herein may be implemented on a variety of different computing devices. These include general purpose or special purpose computing system environments or configurations. Examples of computing systems, environments, and/or configurations that may be suitable for use with the described configurations include, but are not limited to, personal computers, server computers, game consoles, hand-held or laptop devices, tablet computers, keyboard, computer pointing devices including a mouse, a pointing device, a touchpad, a stylus/pad combination, a joystick, a trackball, a system that receives input signals based on one or more gestures (for example, but not limited to, a movement of a user's finger, hand, head, arm or eye), voice commands, an audio device including wireless headphones or an earpiece, wireless computer goggles, a display or monitor including a video display or television, multiprocessor systems, microprocessor-based systems, programmable consumer electronics, network PCs, minicomputers, mainframe computers, distributed computing environments that include any of the above systems or devices, and the like, and mobile devices, e.g., phones, smartphones, Personal Digital Assistants (PDAs), Ultra-Mobile Personal Computers (UMPCs), Mobile Internet Devices (MIDs), etc.

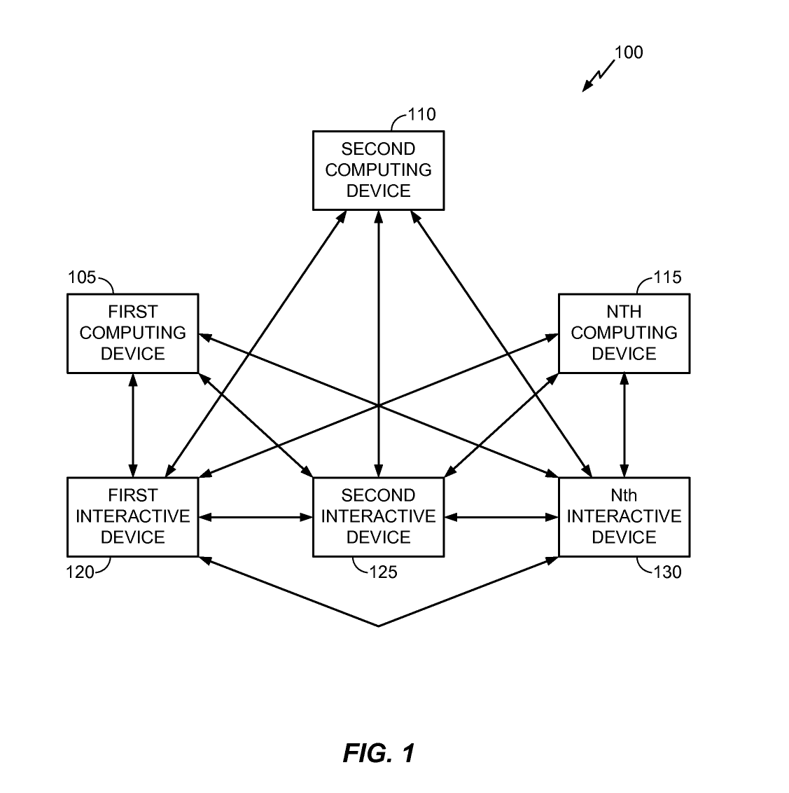

FIG. 1 is a schematic illustrating an example of a system 100 depicting a plurality of interactive devices 120, 125 and 130 in communication with a plurality of computing devices 105, 110 and 115 in an active connection mode and the other of the plurality of computing devices in a standby or inactive communication mode. The illustrated system includes a first computing device 105 and a second computing device 110. In some systems, and as illustrated in FIG. 1, the system 100 includes an Nth computing device 115 representing that there can be any number of more than two computing devices. Any of the computing devices 105, 110 and 115 can be, for example, a desktop computer, server computer, hand-held or laptop computer, tablet computer, a television, a video or television system, or a mobile computing device including but not limited to a cellular telephone, smartphone, Personal Digital Assistant (PDA), Ultra-Mobile Personal Computer (UMPC), or a Mobile Internet Device (MID), etc. In the configurations and examples discussed further herein, the computing devices are configured for wireless communication with other devices, however, in some implementations at least one of the computing devices may have wired connections to one or more other devices, in which case communications described herein with respect to wireless communications may be implemented by wired communication technology.

The system 100 also includes a wireless first interactive device 120 and a wireless second interactive device 125. In some systems, and as illustrated in FIG. 1, the system 100 includes a wireless Nth interactive device 130 representing that there can be any number of more than two interactive devices. Any of the interactive devices 120, 125 and 130 can be, for example, a keyboard, a computer pointing device including a mouse, trackball, track pad or sensing pad, a joystick, an audio device including wireless headphones or an earpiece, wireless computer goggles, a display or monitor including a video display or television, or another interactive device for communicating with a computing device. In the implementations and examples discussed further herein, interactive devices may be configured for wireless communication with other devices, however, in some implementations at least one of the computing devices may have wired connections to one or more other devices, in which case communications described herein with respect to wireless communications may be implemented by wired communication technology.

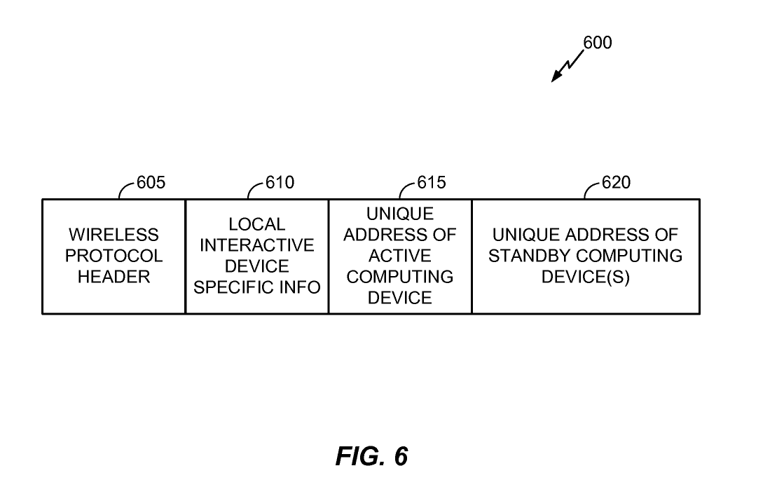

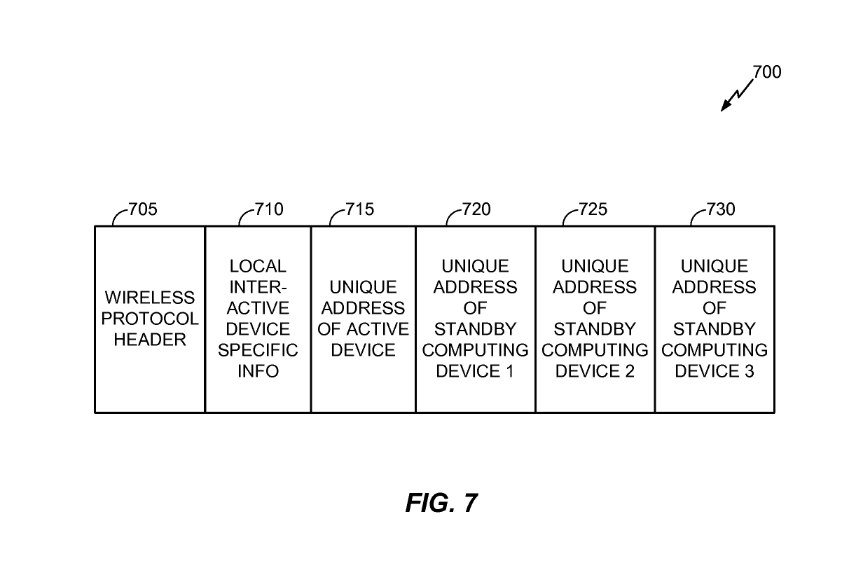

The example in FIG. 1 also illustrates, by the arrows, general communications between the interactive devices 120, 125 and 130 and the computing devices 105, 110 and 115. The interactive devices 120, 125 and 130 are configured to wireles sly communicate with each other, including communicating data packets that include information identifying the interactive device transmitting the information, the address of the computing device which is the active device, and the address of one or more computing devices which are standby (or “inactive”) devices. Data packets are further discussed in reference to FIGS. 6 and 7. A computing device that is indicated to be an active device is a device that the interactive device is communicating with in an active connection mode. An active connection mode is a communication mode, of the transmitting interactive device identified in the data packet and the active computing device identified in the data packet, to wireles sly communicate interactive user information input into the interactive device to the active computing device identified in the data packet, or to wireles sly receive, at the interactive device identified in the data packet, output data from the active computing device identified in the data packet to communicate to the user. A computing device that is indicated to be a standby device is a device that the interactive device is communicating with in a standby (or inactive) connection mode. A standby connection mode is a communication mode, of the transmitting interactive device identified in the data packet and of a standby computing device identified in the data packet, to wireles sly communicate to identify the presence of the interactive device and the standby computing device to each other but not to communicate interactive user information input into the interactive device to the standby computing device or to communicate output data from the standby computing device to the transmitting interactive device identified in the data packet.

The interactive devices 120, 125 and 130 are also configured to wireles sly communicate with the computing devices 105, 110 and 115 as active devices or as standby devices, a designation which may change as the interactive devices 120, 125 and 130 are switched to communicate with one of the computing devices 105, 110 and 115 as an active device and the other computing devices as standby devices. The wireless communications can use any appropriate wireless protocol, for example, Bluetooth. The interactive devices 120, 125 and 130 may advertise their active and standby computing device connections by transmitting data packets. In one example, at one point the first interactive device 120 is in active connection mode with the first computing device 105. The first interactive device 120 advertises that it is in active connection mode with first computing device 105 by sending a data packet “Packet 1,” for example, of the form illustrated in FIG. 6. Packet 1 is one example of a data packet, but other forms of a data packet may also be used. The other interactive devices 125 and 130 are configured to receive data packets from the other interactive devices. In this example, the interactive devices 125 and 130 use information in the received Packet 1 type data packet to determine that the first interactive device 120 has an active connection mode with the first computing device 105.

The first interactive device 120 may be placed in an active connection mode with the second computing device, either by user initiation or other means, for example, by following a switch of another interactive device to the second computing device 110, or other means. In some implementations, the first interactive device 120 may be a keyboard and receives a command from a user using the user interface of the interactive device (for example, a certain key or button on the keyboard, or a combination of keys or buttons on the keyboard). The interactive devices are configured to generate data packets that include information to advertise to the other interactive devices their current connections with the computing devices. The first interactive device 120 now may advertise its active connection mode with the second computing device 110 and its connections to other computing devices 105 and 115 are standby connections by transmitting a data packet “Packet 2,” for example, of the form illustrated in FIG. 7. Packet 2 is another example of a data packet, but other forms of a data packet may also be used.

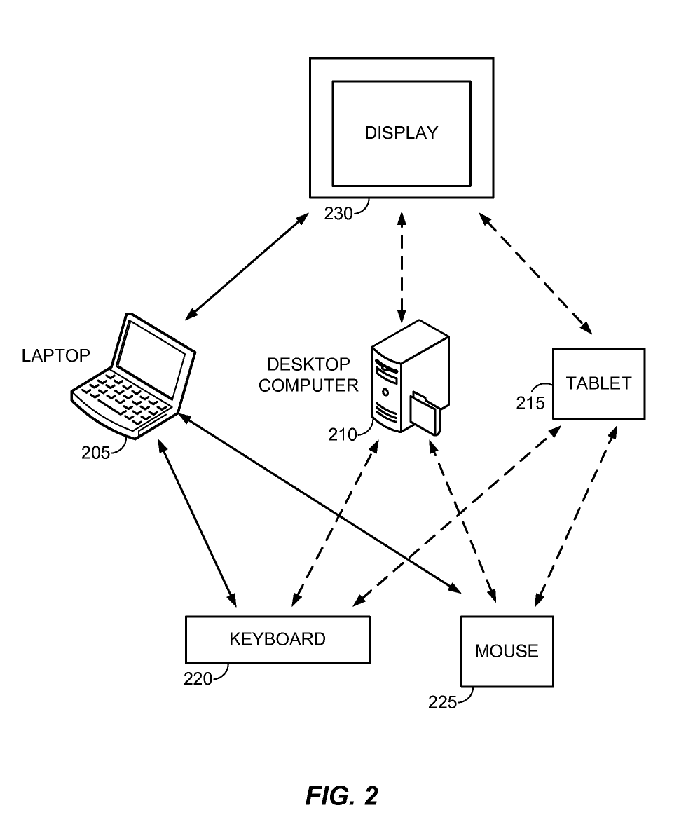

The other interactive devices 125 and 130 can receive Packet 2 and use the information therein to switch their active connection mode from the first computing device 105 to the second computing device 110. The first interactive device 120 can later switch its active connection mode from the second computing device 110 to the first computing device 105. The first interactive device 120 may advertise that it is in an active connection mode with the first computing device 105 and other connections to other computing devices 110 and 115 are in standby by transmitting a data packet of the form of Packet 2. The second interactive device 125 and the Nth interactive device 130 can receive the data packet in the form of Packet 2 sent by the first interactive device 120 and use information in the data packet to switch their active connection modes from the second computing device 110 back to the first computing device 105 without any user intervention. Further examples of these techniques are described with reference to FIGS. 2-4.

FIG. 2 is a schematic illustrating one example of three interactive devices wirelessly connected to a first computing device (a laptop 205) in an active connection mode and wirelessly connected to a second computing device and a third computing device, in a standby communication mode. In this example, the second computing device is a desktop computer 210 and the third computing device is a tablet computer 215, and the desktop computer 210 and the tablet computer 215 are standby devices. The three interactive devices, a wireless keyboard 220, mouse 225 and display 230, are wirelessly connected to the laptop computer 205 such that the interactive devices are communicating with the laptop computer 205 to provide user input to the laptop computer 205 (for example, via the keyboard 220 and the mouse 225) and/or are receiving output from the laptop computer 205 to communicate to the user (for example, via the display 230). The solid lines connecting the keyboard 220, mouse 225 and display 230 to the laptop computer 205 represent that the keyboard 220, mouse 225 and display are connected to the laptop computer 205 in an active connection mode at an initial state, as illustrated in FIG. 2. In other examples, each interactive device may be connected to either the desktop computer 210 or the tablet computer 215 in the initial state. The dashed lines connecting the keyboard 220, mouse 225 and display 230 to the desktop computer 210 and to the tablet computer 215 indicate that the keyboard 220, mouse 225 and display 230 are in an inactive connection mode with the desktop computer 210 and the tablet computer 215. In this configuration the desktop computer 210 and the tablet computer 215 are standby devices. As the desktop computer 210 and tablet computer 215 are standby devices in an inactive connection mode, their addresses are known to the keyboard 220, mouse 225 and display 230, and the keyboard 220, mouse 225 and display 230 may be easily connected to the desktop computer 210 and the tablet computer 215 in an active connection mode if such a connection is desired.

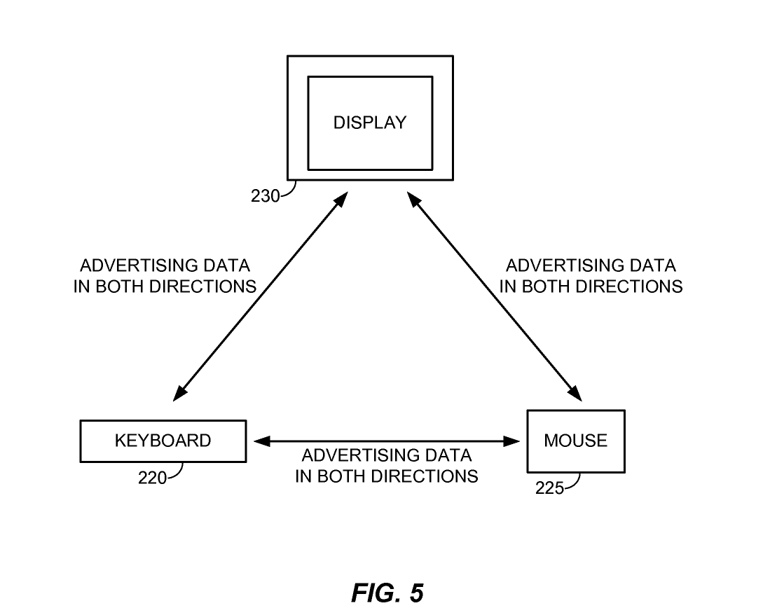

Still referring to FIG. 2, each interactive device is configured to advertise its connection to the computing devices by wirelessly communicating with the other interactive devices. For example, each of the keyboard 220, mouse 225 and display 230 are configured to advertise its connection to the laptop computer 205, the desktop computer 210 and the tablet computer 215 by wirelessly communicating with the other interactive devices. This is further illustrated in FIG. 5, where each interactive device is illustrated as transmitting and receiving data packets to the other interactive devices informing the other interactive devices of its connection status. Advertising the connections of an interactive device may be performed, using any appropriate wireless communication process, by broadcasting a packet such as Packet 1 for the initial configuration (or connection mode) and Packet 2 for a subsequent connection mode, illustrated and further described below in FIGS. 6 and 7, respectively. In the configuration illustrated in FIG. 2, the laptop 205 is the “active device” and the desktop computer 210 and the tablet computer 215 are the first and second standby devices, respectively.

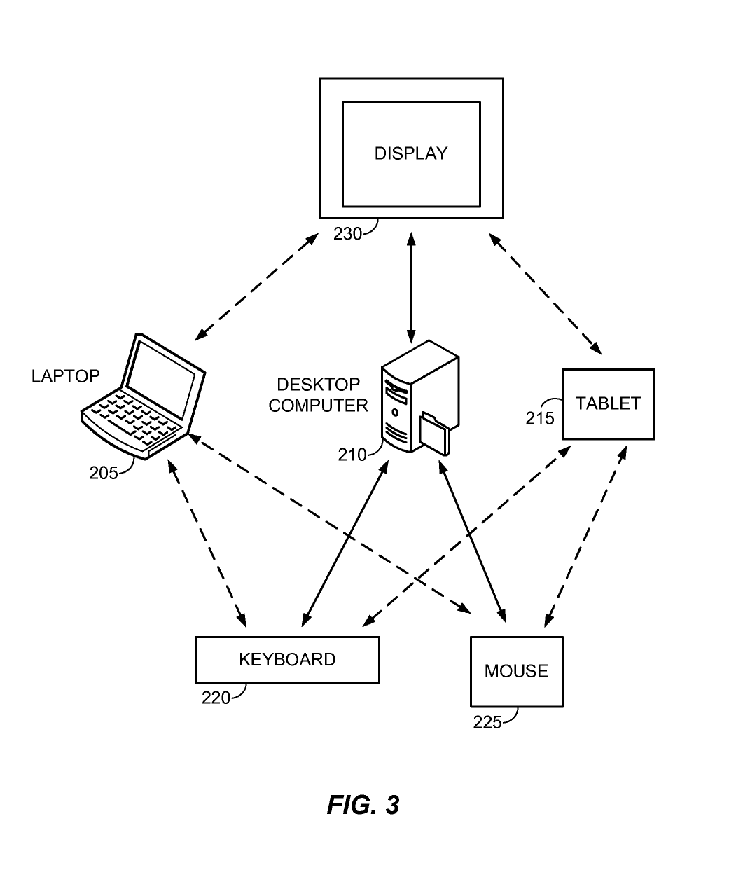

FIG. 3 is a schematic illustrating an example of the three interactive devices illustrated in FIG. 2 (i.e., the keyboard 220, the mouse 225 and the display 230) now wireles sly connected to a second computing device (for example, the desktop computer 210) in an active connection mode and wirelessly connected to the two other computing devices (e.g., the laptop computer 205 and the tablet computer 215) in an inactive communication mode. The active and standby communication links are illustrated by the solid and dashed lines, respectively. Accordingly, FIG. 3 illustrates the connections of the interactive devices (the keyboard 220, the mouse 225 and the display 230) after one of the interactive devices has been switched to actively communicate with the desktop computer 210 and the other two interactive devices have “followed” the first interactive device and are now also connected to the desktop computer 210.

In other examples, any one of the interactive devices may be the first interactive device to be switched to the desktop computer. For example, the keyboard 220 may be switched to actively communicate with the desktop computer 210 by, for example, by a user selecting a soft (on display) or hard (on keyboard) input button. While the keyboard 220 is connected to the laptop computer 205, the keyboard 220 wirelessly communicates to the mouse 225 and to the display 230 its active connection, and the mouse 225 and the display 230 also advertise their active connections. Once the keyboard 220 switches to the desktop computer 210, the keyboard 220 now advertises that it is connected to the desktop computer 210 and that the laptop computer 205 is a standby device in an inactive connection mode. The mouse 225 and the display 230 receive the communication from the keyboard 220 and also switch to have an active mode connection to the desktop computer 210 and an inactive connection mode to the laptop computer 205 and the tablet computer 215 (now standby devices). The new connections are transmitted by each interactive device, and each interactive device may be configured to then confirm that they are in-sync with the other interactive devices, for example, they are connected to the same active device.

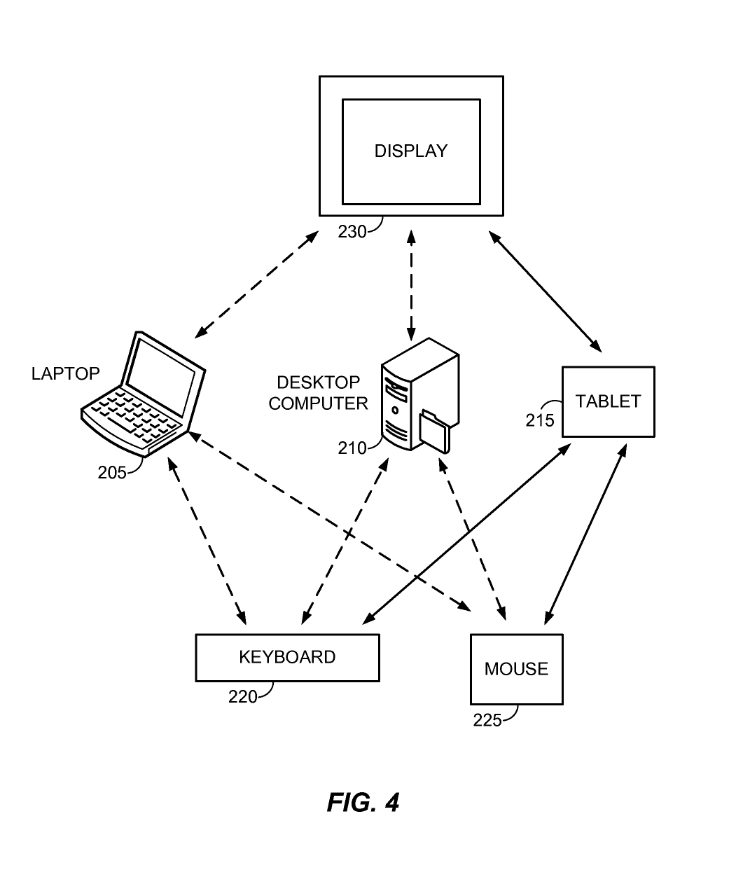

FIG. 4 is a schematic illustrating an example of the three interactive devices illustrated in FIGS. 2 and 3 (that is, the keyboard 220, mouse 225, and display 230) now wirelessly connected to a third computing device (the tablet computer 215) in an active connection mode and wirelessly connected to the two other computing devices (e.g., the laptop computer 205 and the desktop computer 210) in an inactive communication mode. FIG. 4 illustrates the active connections (in solid lines) and the standby connections (in dashed lines) when one of the interactive devices has been switched to communicate actively with the tablet computer 215 and the other two interactive devices have followed the first interactive device to also connect with the tablet computer 215.

FIG. 5 illustrates communications between a set of three interactive devices (the keyboard 220, mouse 225 and display 230) illustrated in FIGS. 2-4. The interactive devices 220, 225 and 230, which may be referred to as a set of interactive devices, are configured to generate wirelessly communicated data packets to other devices in the set of interactive devices. The keyboard 220, mouse 225 and display 230 may be configured to determine the connections of another interactive device based on information in a wirelessly received data packet. The information in a data packet can be saved in a memory unit of the interactive device receiving the packet, and then checked by the receiving interactive device against information contained in more recently received data packets to determine if a connection status of one of the other interactive devices has changed. By “advertising” its own connections, each of the keyboard, mouse and display interactive devices provides information to the other interactive devices that enables the interactive devices to maintain communicating, as a set, to the same active device.

FIG. 6 illustrates an example of representative data packet 600 that may be generated and communicated between the interactive devices illustrated in FIGS. 1-5 when an interactive device is an active connection mode with one computing device (e.g., one of laptop computer 205, desktop computer 210, tablet computer 215) and with no standby computing devices in an inactive (or standby) communication mode. For example, this data packet may be an initial data packet sent to other interactive devices when an interactive device generating the data packet 600 has not been connected to more than one computing device. This may occur, for example, in a startup condition. The data packet 600 may include a wireless protocol header information field 605 that is specific to the protocol being used for communication between a set of interactive devices.

The data packet 600 may also include a local interactive device specific information field 610 that can include information of the interactive device that generated and transmitted the data packet 600. The local interactive device specific information field 610 may include the unique address of the interactive device that generated the data packet 600. In some implementations, the local interactive device specific information field 610 may include information related to active and/or standby (or inactive) computing devices. For example, one or more of the active and/or inactive computing devices that are referred to in data packet 600 or that are in communication with the interactive device that generated data packet 600. In some implementations, the local interactive device information field 610 may include the number of active computing devices and/or the number of standby (or inactive) computing devices. In some implementations, a computing device (for example, first computing device 105 of FIG. 1) or an interactive device (for example, first interactive device 120 of FIG. 1) may be configured to read the number of active and inactive computing devices and having this information, be better able to determine when to stop processing a received data packet as it will know how many fields there are in a packet.

Still referring to FIG. 6, the data packet 600 may also include an active computing device field 615 that includes information identifying the address of an active computing device. The active computing device is the device that an interactive device that generated the data packet is in an active connection mode with, for example, communicating input to and/or receiving output from. The data packet 600 may also include a standby computing device field 620. In the data packet illustrated in FIG. 6, the standby computing device field 620 may only include zeros as there are no devices in standby initially. In some implementations, other characters may be included to indicate there are no standby devices, or the standby computing device field 620 may be left out of the data packet 600. In some instances, the data packet 600 illustrated in FIG. 6 may be sent during the initial state (for example, upon startup) and there may not be any standby computing devices (or previously connected computing device) information to include in the data packet 600.

FIG. 7 illustrates an example of an implementation of a data packet 700 that may be generated and transmitted by an interactive device, for example, interactive devices illustrated in FIGS. 1-5. The data packet 700 is an example of a representative packet that may be communicated between interactive devices when an interactive device is in an active connection mode with a computing device (for example, a laptop computer) and in a standby connection mode with other computing devices, in this example three other computing devices. Similar to the packet illustrated in FIG. 6, the data packet 700 may include fields for a wireless protocol header 705, local interactive device specific information 710, and the unique address of an active computing device 715. The data packet 700 may also include fields for information for each computing device previously connected to the interactive device generating the data packet 700, illustrated in this example as a unique address of standby device fields 720, 725 and 730. For example, a unique address of a first standby computing device most recently connected to the interactive device generating the data packet 700 in field 720; a unique address of a second standby computing device that was the second computing device most recently connected to the interactive device generating the data packet 700 in field 725; and a unique address of a third standby computing device that was the third computing device most recently connected to the interactive device generating the data packet 700 in field 730. That is, information of a previously connected computing device may reside in the Unique Address of Standby Device 1 field 720, information of other previously connected computer devices may reside in the Unique Address of Standby Device 2 field 725 and the Unique Address of Standby Device 3 field 730. In some implementations, the order of the fields 720, 725 and 730 related to standby devices is ordered such that the most recent previously connected device is listed in an earlier field, for example, a field closer to the beginning of the data packet 700. In some implementations, there is no particular order to the Unique Address of Standby Device fields 720, 725 and 730, and the data packet 700 may include other information indicating which of the standby devices was most recently connected.

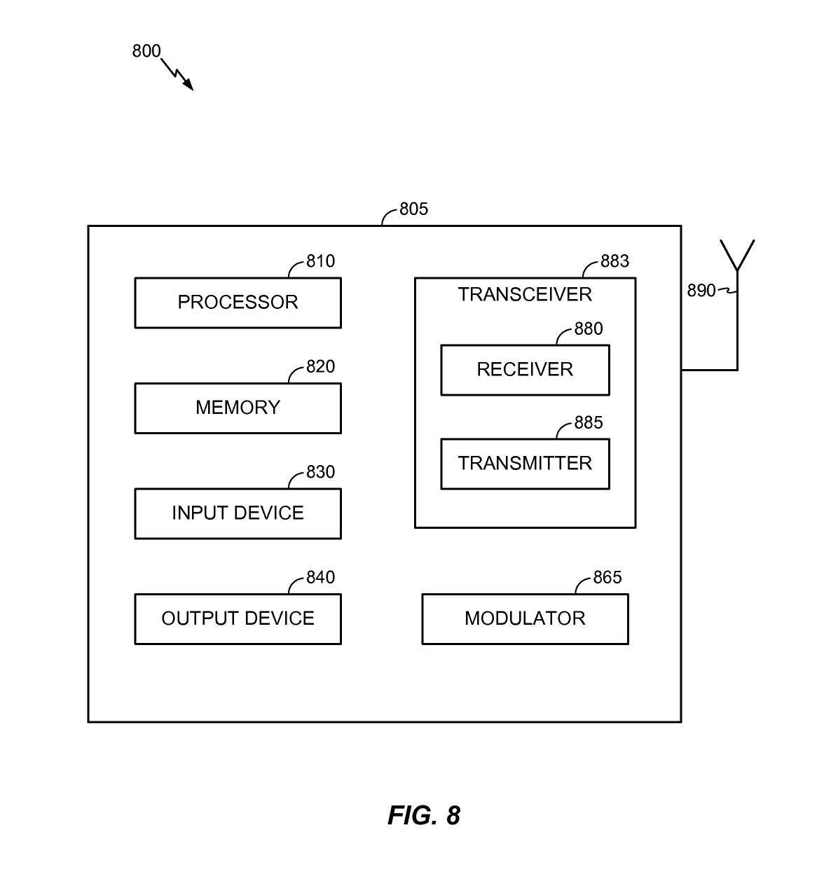

FIG. 8 is a schematic illustrating an example of one implementation of a wireless interactive device 800. Interactive device 800 may include a housing 805 surrounding most or all of its operational components. Interactive device 800 may also include a processor 810 operationally coupled to a memory unit 820. The memory unit 820 may be incorporated on the same chip as the processor 810, or be components of memory included on the processor 810 or be a separate component. The interactive device 800 may also include an input device 830, for example, a user interface. Specifically, the input device 830 may include, for example, a button, switch, or a structure that accepts an input via contact or near contact (for example a touchscreen). The interactive device 800 may also include an output device 840, for example a display screen. In some implementations, the interactive device 800 may not have an output device 840 (for example, a mouse), and instead indicate its on another device (for example, the screen of a computer in communication with the output device 840). The interactive device 800 may also include an antenna 890, a transmitter 885 configured to communicate wirelessly with other interactive devices, computing devices or other communication devices or systems, and a receiver 880 configured to communicate wirelessly with other devices, including other interactive devices and computing devices. The interactive device 800 may include a transceiver 883 that includes the transmitter 885 and the receiver 880.

The processor 810 is configured to perform logical, computational, and control operations for the device, for example, generating data packets that include active and standby device information, and processing communications received from other wireless devices and computers. Memory unit 820 is configured to store data, including the information the interactive device 800 may receive in data packets from other interactive devices. Output device 840 may be configured to output data or information to a user, and may include a screen to display text or images to convey information to the user. The output device 840 may include a speaker to provide audio to a user, and/or an audio connection to connect to an external audio device, for example, headphones or an earpiece.

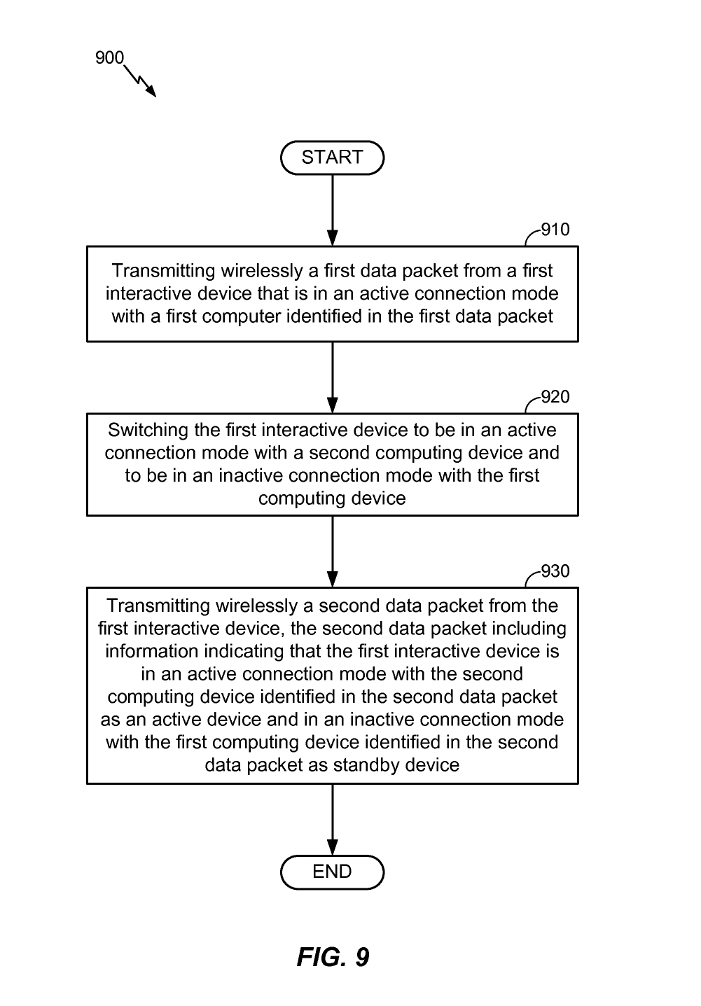

FIG. 9 is a flowchart 900 illustrating an example of a method for switching a set of interactive devices from a first computer to a second computer. In this example, at block 910 the method 900 may transmit wirelessly a first data packet from a first interactive device that is in an active connection mode with a first computer identified in the first data packet. The data packet may include information identifying the interactive device transmitting the data packet and identifying an active computing device that is in an active connection mode with the interactive device transmitting the data packet. The data packet may further include information identifying any standby computing devices that are in an inactive connection mode with the interactive device transmitting the data packet. This portion of the method 900 can be performed by a processor operationally coupled to a transmitter.

At block 920, the method 900 may include switching the first interactive device to be in an active connection mode with a second computing device and in an inactive connection mode with the first computing device. In some implementations, a first interactive device may include a user interface to receive user input to indicate instructions to switch the interactive device to a different computing device, and a processor to receive and process signals from the user interface to switch the first interactive device to be in an active connection mode with a second computing device and in an inactive connection mode with the first computing device.

At block 930, the method 900 may include transmitting wirelessly a second data packet from the first interactive device. The second data packet may include information indicating that the first interactive device is in an active connection mode with the second computing device identified in the second data packet as an active device and in an inactive connection mode with the first computing device identified in the second data packet as a standby device. When there is more than one standby device, the data packet can include the standby devices in a particular order to indicate which of the standby devices was most recently connected to the first interactive device. In other implementations, the data packet can include additional information to indicate which of the standby devices was most recently connected to the first interactive device.

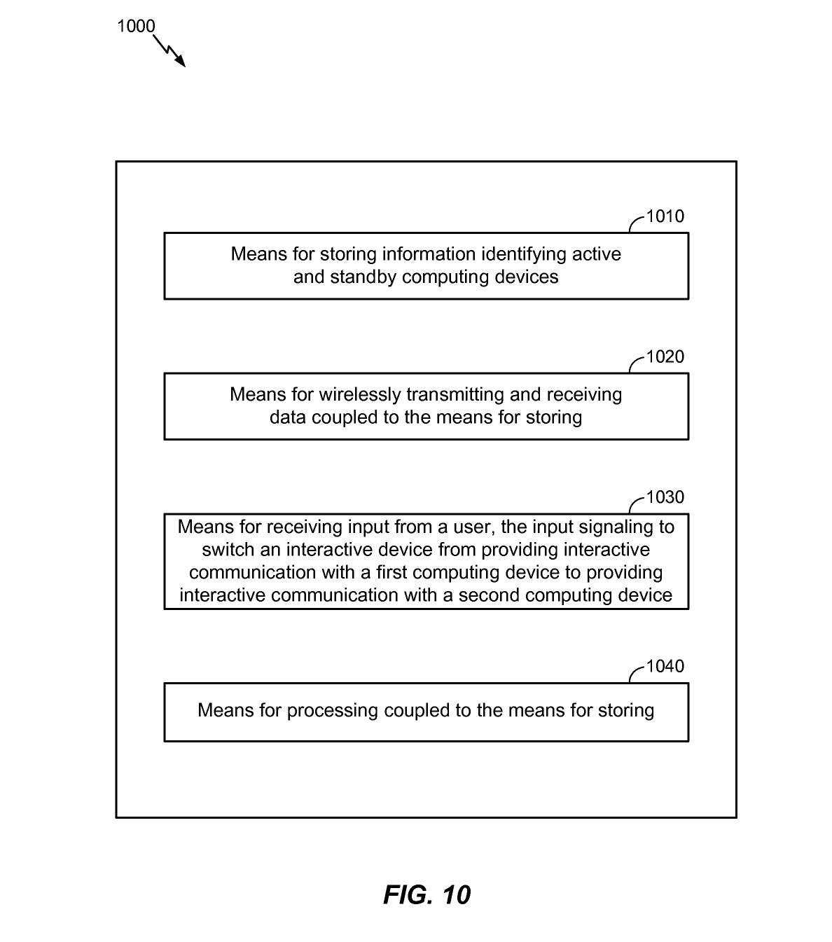

FIG. 10 is a block diagram of an interactive device 1000 that may be used in implementations of the invention. The device 1000 includes in block means for storing information 1010 identifying active and standby computing devices. The means for storing information 1010 may include a memory unit or component, either configured as part of a processor or as a separate component. The device 1000 also includes means for wirelessly transmitting and receiving data 1020 coupled to the means for storing. The means for wirelessly transmitting and receiving data 1020 may include a transmitter and a receiver, or a transceiver incorporating a transmitter and receiver.

The device 1000 may also include means for receiving input from a user 1030, the input signaling to switch the interactive device from providing interactive input from a first computing device to a second computing device. The means for receiving input 1030 may include a user interface for example, a button, switch, or a structure that accepts an input via contact or near contact (for example a touchscreen). The device 1000 may also include means for processing 1040, coupled to the means for storing 1010. The processing means 1040 also for retrieving the information identifying active and standby computing devices from the memory unit, generating a data packet that includes specific information of the first interactive device, address information of an active computing device and address of one or more standby computing devices, and information indicating which of the standby devices was more recently connected to the first interactive device, and for wireles sly transmitting the data packet in coordination with the means for transmitting 1020. The means for processing may include a processor or a plurality of processors.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of: A, B, or C” used in the description or the claims means “A or B or C or any combination of these elements.”

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of two computing components, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects, a computer readable medium may comprise non-transitory computer readable medium (e.g., tangible media). In addition, in some aspects a computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims. Processes or steps described in one implementation can be suitably combined with steps of other described implementations.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A system for switching wireless connections of a plurality of interactive devices from a first computing device to at least a second computing device, comprising:
a first interactive device, comprising:
a memory unit configured to store information identifying active and standby computing devices;
a wireless transmitter and receiver operationally coupled to the memory unit;
an interface configured to receive user input signaling to switch the interactive device from providing interactive input from a first computing device to a second computing device; and
a processor coupled to the memory unit, the processor configured to retrieve the information identifying active and standby computing devices from the memory unit, generate a data packet that includes specific information of the first interactive device, address information of an active computing device and address of one or more standby computing devices, and information indicating which of the standby devices was more recently connected to the first interactive device, and to wirelessly transmit the data packet using the transmitter.

2. The system of claim 1, wherein the data packet comprises information of the one or more standby computing devices in a particular order, the order indicating which of the one or more standby computing devices was more recently an active computing device.

3. The system of claim 1, wherein the processor is further configured to wirelessly communicate with one or more computing devices including the second computing device to identify their presence as standby computing devices that are candidates to be an active computing device.

4. The system of claim 1, wherein the interactive device is a wireless keyboard.

5. The system of claim 1, further comprising a second interactive device configured to receive the data packet sent from the first interactive device and to switch to be in an active connection mode with the computing device identified to be the active computing device in the received data packet.

6. The system of claim 5, wherein the second interactive device is further configured to switch to be in an inactive connection mode with a standby computing device that the second interactive device was previously connected to as an active computing device.

7. The system of claim 6, wherein the second interactive device is further configured to generate and wirelessly transmit a data packet that includes information specific to the interactive device, identification information of an active computing device connected to the second interactive device, and identification information of one or more standby computing devices, the data packet generated by the second interactive device including information to indicate which of the one or more standby computing devices was more recently connected to the second interactive device as an active computing device.

8. The system of claim 5, wherein the second interactive device comprises a display device, a mouse, a touch pad, a track ball pointing device, or a tablet pointing device.

9. A method for switching wireless connections of a plurality of interactive devices from a first computing device to at least a second computing device, the method comprising:
transmitting wireles sly a first data packet from a first interactive device that is in an active connection mode with a first computer identified in the first data packet, the data packet including information identifying the interactive device transmitting the data packet and identifying an active computing device that is in an active connection mode with the interactive device transmitting the data packet, the data packet further including information identifying any standby computing devices that are in an inactive connection mode with the interactive device transmitting the data packet;
switching the first interactive device to be in an active connection mode with a second computing device and in an inactive connection mode with the first computing device; and
transmitting wireles sly a second data packet from the first interactive device, the second data packet including information indicating that the first interactive device is in an active connection mode with the second computing device identified in the second data packet as an active device and in an inactive connection mode with the first computing device identified in the second data packet as a standby device.

10. The method of claim 9, wherein
the active connection mode indicates a communication mode, of the transmitting interactive device identified in the data packet and the active computing device identified in the data packet, to wirelessly communicate interactive user information input into the interactive device to the active computing device identified in the data packet or to wirelessly receive, at the interactive device identified in the data packet, output data from the active computing device identified in the data packet to communicate to the user, and
the inactive connection mode indicates a communication mode, of the transmitting interactive device identified in the data packet and a standby computing device identified in the data packet, to wireles sly communicate to identify the presence of the interactive device and the standby computing device but not to communicate interactive user information input into the interactive device to the standby computing device or to communicate output data from the standby computing device to the transmitting interactive device identified in the data packet.

11. The method of claim 9, further comprising:
receiving, by at least one other interactive device, the first data packet via a wireless network;
if the at least one other interactive device is not in an active connection mode with the active computing device identified in the received first data packet, switching the at least one other interactive device to an active connection mode with the active computing device identified in the first data packet;
receiving the second data packet at the at least one other interactive device; and
connecting the at least one other interactive device to be in active connection mode with the second computer and an inactive connection mode with the first computer based on information in the second data packet.

12. The method of claim 9, further comprising:
transmitting a third data packet from the at least one other interactive device, the data packet including information indicating the second computing device is in an active connection mode the at least one other interactive device transmitting the third data packet and including information indicating the first computing device is in an inactive connection mode with the at least one interactive device transmitting the third data packet.

13. The method of claim 12, further comprising:
switching the first interactive device to be in an active connection mode with a third computing device and in an inactive connection mode with the first computing device and the second computing device; and
transmitting a fourth data packet from the first interactive device, the third packet including information indicating that the first interactive device is in an active connection mode with the third computing device and in an inactive connection mode with the first and second computing devices.

14. The method of claim 13, further comprising:
receiving the fourth data packet at the at least one other interactive device;
switching the at least one other interactive device to an active connection mode with the third computing device and an inactive connection mode with the first and second computing devices based on information in the fourth data packet; and
transmitting from the at least one other interactive device a data packet including information indicating the at least one other interactive device is in an active connection mode with the third computing device and in an inactive connection mode with the first and second computing devices.

15. The method of claim 9, wherein the first interactive device comprises a keyboard, a mouse, a display, or a printer, and wherein each of the at least one other interactive devices comprise a keyboard, a mouse, a display, or a printer.

16. The method of claim 9, wherein the second data packet comprises:
information specific to the interactive device sending the data packet;
a unique address of an active computing device; and
the unique address of at least one standby device.

17. The method of claim 13, wherein the fourth data packet comprises:
information specific to the interactive device sending the data packet;
a unique address of an active computing device; and
a plurality of unique addresses of standby devices, wherein the plurality of unique addresses of the standby devices in the fourth data packet are ordered such that a unique address of a standby device that was more recently in an active connection mode with the interactive device appears before a standby device that was less recently in an active connection with the interactive device.

18. A non-transitory computer readable medium comprising instructions that, when executed, cause an apparatus to perform a method for switching wireless communications of a plurality of interactive devices from a first computer to at least a second computer, the method comprising:
transmitting wireles sly a first data packet from a first interactive device that is in an active connection mode with a first computer identified in the first data packet, the data packet including information identifying the interactive device transmitting the data packet and identifying an active computing device that is in an active connection mode with the interactive device transmitting the data packet, the data packet further including information identifying any standby computing devices that are in an inactive connection mode with the interactive device transmitting the data packet;
switching the first interactive device to be in an active connection mode with a second computing device and in an inactive connection mode with the first computing device; and
transmitting wireles sly a second data packet from the first interactive device, the second data packet including information indicating that the first interactive device is in an active connection mode with the second computing device identified in the second data packet as an active device and in an inactive connection mode with the first computing device identified in the second data packet as standby device.

19. The computer readable medium of claim 18, wherein the data packet comprises information of the one or more standby computing devices in a particular order, the order indicating which of the one or more standby computing devices was more recently an active computing device.

20. The computer readable medium of claim 18, wherein the first interactive device comprises a keyboard, a mouse, a display, or a printer, and wherein each of the at least one other interactive devices comprise a keyboard, a mouse, a display or a printer.
